(19) United States
(12) Patent Application Publication
(10) Pub. No.: US 2014/0025577 A1
(43) Pub. Date: Jan. 23, 2014

(54) SYSTEM AND METHOD FOR SECURE TRANSACTIONS UTILIZING PASSIVE NEAR-FIELD COMMUNICATIONS DEVICES

(71) Applicant: Slawomir LISZNIANSKI, Geneva, IL (US)

(72) Inventor: Slawomir LISZNIANSKI, Geneva, IL (US)

(21) Appl. No.: 13/605,372

(22) Filed: Sep. 6, 2012

Related U.S. Application Data
(60) Provisional application No. 61/672,373, filed on Jul. 17, 2012.

(51) Int. Cl. G06Q 20/40; H04B 5/00

(52) U.S. Cl. 705/44

(57) ABSTRACT

A method for authorizing a transaction between a first party utilizing a client device and a second party, including receiving an authorization request from the second party, the authorization request including first party data and second party data, retrieving stored data corresponding to the first party, comparing at least a portion of the first party data to at least a portion of the stored data corresponding to the first party, generating a first hash value from at least a portion of the authorization request, generating a second hash value from at least a portion of the stored data and at least a portion of the authorization request, and comparing the first hash value and the second hash value.

### CROSS-REFERENCE TO RELATED APPLICATIONS

This application claims priority to U.S. Provisional Patent Application No. 61/672,373, filed Jul. 17, 2012 and entitled SYSTEM AND METHOD FOR SECURE TRANSACTIONS UTILIZING PASSIVE NEAR-FIELD COMMUNICATIONS DEVICES, the entire contents of which are hereby incorporated by reference.

### BACKGROUND

Passive near-field communication (NFC) devices are unpowered NFC devices. To function, the passive NFC device modulates the radio frequency field that is generated by an initiator device.

Passive NFC devices have many qualities which make them desirable as artifacts used in a transaction authorization. Such devices may be produced at a low cost, may have a small size, and maybe embedded in other devices or personal jewelry, such as a wristbands, etc. Furthermore, passive NFC devices do not require physical contact with the initiator devices and are thus not subject to the wear that is typical with magnetic strip or chip card technologies.

However, passive NFC devices typically have limited to no processing capacity, and are traditionally unable to offer a secure method of payment authorization. As the data stored on a passive NFC device is not inherently protected, it is relatively simple to produce a forged copy of a particular device. A forged copy can be produced by having momentary physical access to the device, eavesdropping on vendor-consumer communications, or blind trial.

Without modification to the traditional method, using a passive NFC device has no security measures beyond what are offered by a credit card. The addition of a PIN provides the same level of security as a typical transaction at an ATM using a keypad for entry. A solution that may be capable of detecting unauthorized transaction attempts even if an attacker knows the consumer's PIN is therefore desired.

### SUMMARY

According to at least one exemplary embodiment, a method for authorizing a transaction between a first party utilizing a client device and a second party is disclosed. The method can include receiving an authorization request from the second party, the authorization request including first party data and second party data, retrieving stored data corresponding to the first party, comparing at least a portion of the first party data to at least a portion of the stored data corresponding to the first party, generating a first hash value from at least a portion of the authorization request, generating a second hash value from at least a portion of the stored data and at least a portion of the authorization request, and comparing the first hash value and the second hash value.

According to another exemplary embodiment, a method for secure NFC transaction is disclosed. The method can include establishing an NFC channel between a client device and a terminal of a first party having a first party identification number, transferring client device data from the client device to the terminal, generating a first hash value from at least a portion of the client device data and the first party identification number, writing the first hash value to a memory of the client device, closing the NFC channel, obtaining a personal identification number from a user of the client device, transmitting an authorization request from the terminal to a second party, and obtaining a response, from the second party, to the authorization request. The method can further include evaluating the authorization request by the second party.

According to another exemplary embodiment, a system for secure NFC transactions is disclosed. The system can include at least one client device, the client device having a client device data and a client device transaction history stored thereon, at least one merchant terminal having a merchant identification number and operable to establish a communication channel with the at least one client device, retrieve the client device data and the client device transaction history, generate a first hash value based at least on the merchant identification number and the client device transaction history, write the first hash value to the transaction history of the client device, and generate and send an authorization request, the authorization request containing the client device data, the client device transaction history, and the merchant identification number, and a provider server in communication with the merchant terminal and operable to receive the authorization request, compare the client device data to a server-side data associated with the client device, generate a second hash value based on the merchant identification number and a server-side transaction history associated with the client device, and compare the first hash value to the second hash value.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

FIG. 1 is a diagram of an exemplary computer system.

FIG. 2a is a diagram of an exemplary embodiment of a system for secure transactions.

FIG. 2b is a diagram of an exemplary embodiment of a client device.

FIG. 3 illustrates an exemplary method for provisioning of a client device.

FIG. 4 illustrates an exemplary method of registering a client device.

FIG. 5a illustrates an exemplary method for secure transactions.

FIG. 5b illustrates an exemplary authorization method.

FIG. 6a illustrates an exemplary extended security method for secure transactions.

FIG. 6b illustrates an exemplary extended security authorization method.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiment are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, many of the embodiments described herein are described in terms of sequences of actions to be performed by, for example, elements of a computing device. It should be recognized by those skilled in the art that the various sequence of actions described herein can be performed by specific circuits (e.g., application specific integrated circuits (ASICs)) and/or by program instructions executed by at least one processor. Additionally, the sequence of actions described herein can be embodied entirely within any form of non-transitory computer-readable storage medium such that execution of the sequence of actions enables the processor to perform the functionality described herein. Thus, the various aspects of the present invention may be embodied in a number of different forms, all of which have been contemplated to be within the scope of the claimed subject matter. In addition, for each of the embodiments described herein, the corresponding form of any such embodiments may be described herein as, for example, “a computer configured to” perform the described action.

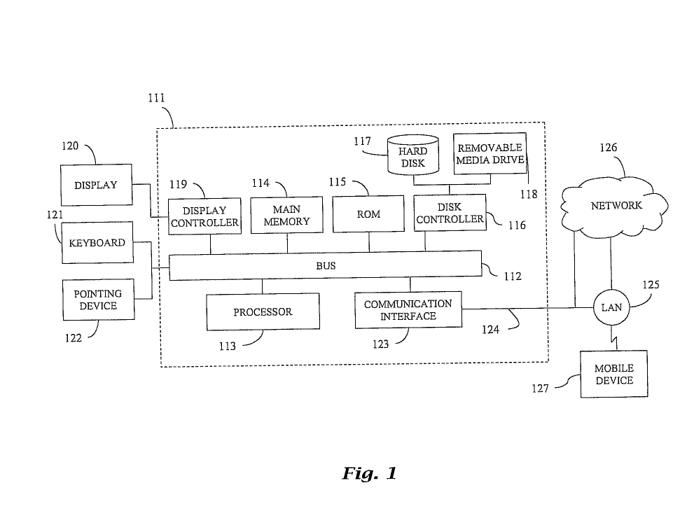

FIG. 1 illustrates a computer system 111 upon which an embodiment of the present invention may be implemented. The computer system 111 includes a bus 112 or other communication mechanism for communicating information, and a processor 113 coupled with the bus 112 for processing the information. The computer system 111 can include a main memory 114, such as a random access memory (RAM) or other dynamic storage device (e.g., dynamic RAM (DRAM), static RAM (SRAM), and synchronous DRAM (SDRAM)), coupled to the bus 112 for storing information and instructions to be executed by processor 113. In addition, the main memory 114 may be used for storing temporary variables or other intermediate information during the execution of instructions by the processor 113. The computer system 111 may further include a read only memory (ROM) 115 or other static storage device (e.g., programmable ROM (PROM), erasable PROM (EPROM), and electrically erasable PROM (EEPROM)) coupled to the bus 112 for storing static information and instructions for the processor 113.

The computer system 111 may include a storage device controller 116 coupled to the bus 112 to control one or more storage devices for storing information and instructions, such as a magnetic hard disk 117, and a media drive 118, which may be any data storage media known in the art such as any known removable media or non-volatile memory. The storage devices may be added to the computer system 111 using an appropriate device interface (e.g., small computer system interface (SCSI), integrated device electronics (IDE), enhanced-IDE (E-IDE), direct memory access (DMA), or ultra-DMA), or any other interface known in the art.

Further, exemplary embodiments include or incorporate at least one database which may store software, descriptive data, system data, digital images and any other data item required by the other components necessary to effectuate any embodiment of the present system known to one having ordinary skill in the art. The database may be provided, for example, as a database management system (DBMS), a relational database management system (e.g., DB2, ACCESS, etc.), an object-oriented database management system (ODBMS), a file system or another conventional database package as a few non-limiting examples. The database can be accessed via a Structure Query Language (SQL) or other tools known to one having skill in the art.

Still referring to FIG. 1, the computer system 111 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 111 may also include a display controller 119 coupled to the bus 112 to control a display 120, such as a cathode ray tube (CRT), liquid crystal display (LCD) or any other type of display, for displaying information to a computer client. The computer system includes input devices, such as a keyboard 121 and a pointing device 122, for interacting with a computer client and providing information to the processor 113. Additionally, a touch screen could be employed in conjunction with display 120. The pointing device 122, for example, may be a mouse, a trackball, or a pointing stick for communicating direction information and command selections to the processor 113 and for controlling cursor movement on the display 120. In addition, a printer may provide printed listings of data stored and/or generated by the computer system 111.

The computer system 111 performs a portion or all of the processing steps of the invention in response to the processor 113 executing one or more sequences of one or more instructions contained in a memory, such as the main memory 114. Such instructions may be read into the main memory 114 from another computer readable medium, such as a hard disk 117 or a media drive 118. One or more processors in a multi-processing arrangement may also be employed to execute the sequences of instructions contained in main memory 114. In alternative embodiments, hard-wired circuitry may be used in place of or in combination with software instructions. Thus, embodiments are not limited to any specific combination of hardware circuitry and software.

As stated above, the computer system 111 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, a carrier wave (described below), or any other medium from which a computer can read.

Stored on any one or on a combination of computer readable media, the present invention includes software for controlling the computer system 111, for driving a device or devices for implementing the invention, and for enabling the computer system 111 to interact with a human client. Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 113 for execution. A computer readable medium may take many forms, including but not limited to, non-volatile media, volatile media, and transmission media. Non-volatile media includes, for example, flash memory, optical disks, magnetic disks, and magneto-optical disks, such as the hard disk 117 or the media drive 118. Volatile media includes dynamic memory, such as the main memory 114. Transmission media includes coaxial cables, copper wire and fiber optics, including the wires that make up the bus 112. Transmission media also may also take the form of acoustic or light waves, such as those generated during radio wave and infrared data communications. Transmission may be accomplished using, for example, a serial port connection, a parallel port connection, USB, IEEE 1394 (FireWire), Bluetooth, Wi-Fi, near-field communication, or any other type of connection or interface known in the art.

Various forms of computer readable media may be involved in carrying out one or more sequences of one or more instructions to processor 113 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 111 may receive the data on the telephone line and use an infrared transmitter to convert the data to an infrared signal. An infrared detector coupled to the bus 112 can receive the data carried in the infrared signal and place the data on the bus 112. The bus 112 carries the data to the main memory 114, from which the processor 113 retrieves and executes the instructions. The instructions received by the main memory 114 may optionally be stored on storage device 117 or 118 either before or after execution by processor 113.

The computer system 111 also includes a communication interface 123 coupled to the bus 112. The communication interface 123 provides a two-way data communication coupling to a network link 124 that is connected to, for example, a local area network (LAN) 125, or to another communications network 126 such as the Internet. As another example, the communication interface 123 may be an asymmetrical digital subscriber line (ADSL) card, an integrated services digital network (ISDN) card or a modem to provide a data communication connection to a corresponding type of communications line. Wireless links, using, for example, Wi-Fi, Bluetooth, or NFC, may also be implemented. In any such implementation, the communication interface 123 sends and receives electrical, electromagnetic or optical signals that carry digital data streams representing various types of information.

The network link 124 typically provides data communication through one or more networks to other data devices. For example, the network link 124 may provide a connection to another computer or remotely located presentation device through a local network 125 (e.g., a LAN or 802.11-compliant wireless network) or through equipment operated by a service provider, which provides communication services through a communications network 126. In preferred embodiments, the local network 124 and the communications network 126 preferably use electrical, electromagnetic, or optical signals that carry digital data streams. The signals through the various networks and the signals on the network link 124 and through the communication interface 123, which carry the digital data to and from the computer system 111, are exemplary forms of carrier waves transporting the information. The computer system 111 can transmit and receive data, including program code, through the network(s) 125 and 126, the network link 124 and the communication interface 123. Moreover, the network link 124 may provide a connection through a LAN 125 to a mobile device 127 such as a personal digital assistant (PDA), laptop computer, tablet computer, smartphone, or cellular telephone. The LAN communications network 125 and the communications network 126 both use electrical, electromagnetic or optical signals that carry digital data streams. The signals through the various networks and the signals on the network link 124 and through the communication interface 123, which carry the digital data to and from the system 111, are exemplary forms of carrier waves transporting the information. The processor system 111 can transmit notifications and receive data, including program code, through the network(s), the network link 124 and the communication interface 123.

Other aspects of the invention may include data transmission and Internet-related activities. See Preston Gralla, How the Internet Works, Ziff-Davis Press (1996), which is hereby incorporated by reference into this patent application. Still other aspects of the invention may utilize wireless data transmission, such as those described in U.S. Pat. Nos. 6,456,645, 5,818,328 and/or 6,208,445, all of which are hereby incorporated by reference into this patent application.

As used herein, the term “common channel” may refer to wired or wireless technologies that allow a device to participate in a network of systems, both local to its environment and located remotely, while providing a secure communication channel. The term “near-field communication channel” or “NFC” may refer to technologies allowing a pair of devices to communicate in close proximity. Such communications may be one-to-one between devices and not directly part of a network. The term “active common device” may refer to a device, or part of a device that can communicate on the common channel and can have an input and output mechanism for a user to interact with the device (e.g., smartphone, tablet, computing device). The term “passive NFC device” can refer to a device, or part of a device that can communicate on the NFC channel with an active NFC device. Such a device may have limited computing capacity, and usually may lack provisions for user input or user output (e.g., an embedded tag). Such a device may further include a fixed-length manufacturer unique serial number, which may be read-only, and a limited amount of writeable memory. Such a device may further be included in an active common device, (e.g., a smartphone having a passive NFC device therein.) The term “active NFC device” may refer to a device, or part of a device, which can initiate and sustain communications with either a passive NFC device or another active NFC device on the NFC Channel (e.g., an NFC tag reader). The term “combined device” may refer to a device that can fulfill the role of an active common device as well as an active NFC device (e.g., a merchant payment machine). The term “forgery” may refer to an illicit replication of a passive NFC device or any part thereof. The term “consumer” may refer to an individual or entity in possession of an active common device or passive NFC device that can receive products or services from a merchant in exchange for payment. The term “merchant” may refer to an individual or entity in possession of a combined device that can provide products or services to a consumer in exchange for payment. The term “eavesdropping” can refer to third-party interception of communications on any channel that can allow the eavesdropper to receive data intended for a different recipient. The term “provider” may refer to an entity that can facilitate transactions between merchants and consumers. The term “PIN” or “personal identification number” can refer to a confidential password shared between a consumer and a provider. The term “hash” can refer to a method by which a fixed length binary string can be created from an arbitrary block of data, such as a secure cryptographic hash function. The term “footprint” may refer to a sequence of data storable on a non-transitory readable medium.

According to at least one exemplary embodiment, a system and method for secure transactions utilizing passive near-field communication devices may be disclosed. The method can include maintaining a historical record of a plurality of attempted transactions on the passive NFC device, and at least one record of the last successful transaction at the provider. The historical record may be used to construct payment request messages which may be difficult to forge, as well as wherein forgeries may have a limited use and may be readily detected. The method can thus result in a secure payment authorization mechanism utilizing, for example, passive NFC devices, a merchant combined device, and a provider. Other embodiments of the method disclosed herein, which may utilize diverse combinations of active, passive and combined devices, may also be contemplated and provided as desired. Additionally, according to at least one exemplary embodiment, a system operable to implement the disclosed methods may be disclosed.

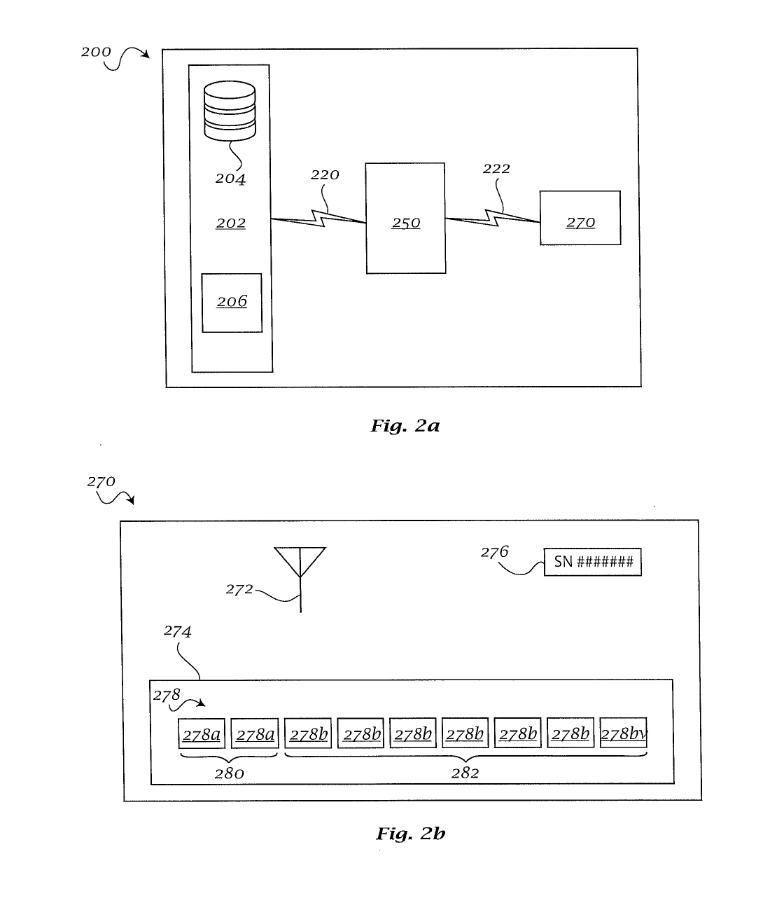

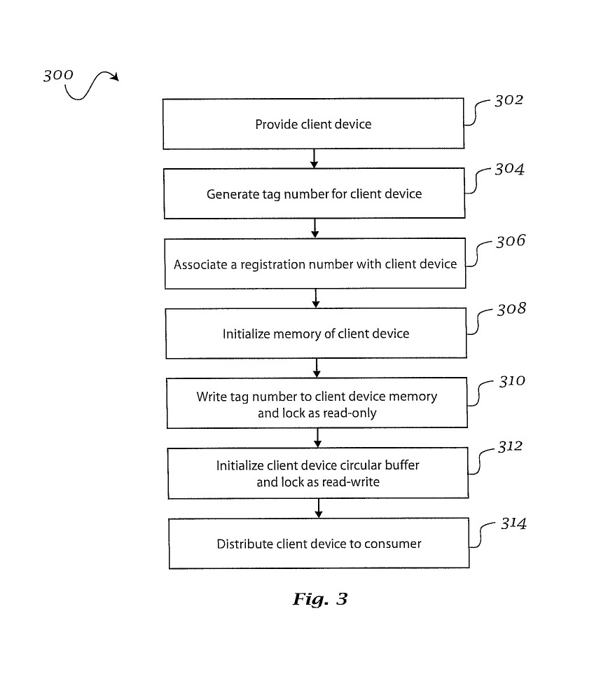

FIG. 2a shows an exemplary embodiment of a system for secure transactions 200. System 200 may include a provider server 202, a merchant terminal 250, and at least one client device 270. Provider server 202 may be operated by a financial transaction provider and may include a database 204 and software 206 adapted to carry out the methods and processes described herein. Merchant terminal 250 may be any known combined device, active NFC device, active common device, or any other device adapted to execute point-of-sale (POS) transactions and NFC-based transactions. In some exemplary embodiments, client device 270 may be a passive NFC device. Provider server 202 and merchant terminal 250 may communicate with each other via a common channel 220. Client device 270 and merchant terminal 250 may communicate with each other via an NFC channel 222.

FIG. 2b shows an exemplary embodiment of a client device 270, wherein the client device is a passive NFC device. In some exemplary embodiments, client device 270 may be compliant with the ISO/IEC 14443 Type A standard. One example of such a device may be the NTAG203 Type 2 tag manufactured by NXP Technologies. Client device 270 may include an antenna 272, a memory 274, and a unique serial number 276. In some exemplary embodiments, unique serial number 276 may be assigned to the client device 270 during manufacture. Memory 274 of the client device 270 may include a plurality of memory pages 278. Each memory page 278 may individually be configured to a “read-write” mode which allows information to both be written to the memory page and read from the memory page, or a “read-only” mode which allows information only to be read from the memory page. In some exemplary embodiments, memory pages 278 of client device 270 may be initially set to a read-write mode at manufacture. However, the mode of each memory page 278 may subsequently be changed to the read-only mode, if desired. Furthermore, the mode of each memory page 278 may be permanently locked, if desired, in the read-only mode or in the read-write mode, thereby disallowing any subsequent mode changes.

In the exemplary embodiment, at least one memory page 278a may be utilized for storing a unique tag number 280 thereon, as described further below. Additionally, a range of memory pages 278b may be utilized as a circular buffer 282, as described further below.

As described above, provider server 202 may include a database 204. Database 204 may be used to store a variety of data in any desired format. In some exemplary embodiments, database 204 may store data relating to at least one client device 270. Such data may include, but is not limited to, a unique serial number 276 pertaining to the client device 270, a unique registration number pertaining to the client device 270, and a unique tag number 280 pertaining to the client device 270. Such data may further include an identification of a consumer utilizing the particular client device 270, a PIN pertaining to the client device 270, as well as the most recent footprint generated by provider server 202 for the particular client device 270, as described further below. In some exemplary embodiments, the above-described data may be associated in with a particular client device 270 via a database record identifiable by the unique tag number 280 of the particular client device 270. The tag number may be written to the client device 270 during the client device provisioning process, as described further below. Additional data stored in database 204 may further include, but is not limited to, consumer-related information for at least one consumer utilizing at least one client device 270, such as personal information, fund provision information, and any other desired information.

FIG. 3 shows an exemplary embodiment of a client device provisioning method 300. In step 302, a provider may provide at least one client device 270, the device having a unique serial number 276. At step 304, the provider may generate a unique tag number 280 and associate the unique tag number to client device 270. Step 304 may be implemented by creating a database record identifiable by unique tag number 280 and associating serial number 276 of client device 270 with the unique tag number 280. At step 306, the provider may generate a unique registration number and associate the unique registration number to the client device 270. Step 306 may be implemented by associating the unique registration number of the device with the unique tag number 280 of the device in database 204. At step 308, the memory 274 of client device 270 may be initialized in any desired memory format.

In some exemplary embodiments, at step 310, unique tag number 280 may be written to the memory pages 278a of client device 270. The memory pages 278a used to store the unique tag number 280 may then be permanently locked in a read-only mode, thereby inhibiting any subsequent alteration of unique tag number 280. At step 312, the circular buffer 282 may be initialized and the memory pages 278b used to store the circular buffer 282 may then be permanently locked in a read-write mode. During initialization of the circular buffer, data may be written thereto. The data may be any undetermined data, such as random data or any other desired data.

At step 314, client device 270 may be distributed to the consumer and corresponding registration number may also be distributed to the consumer. The registration number may be provided to the consumer in a manner such that can facilitate only the intended consumer being informed of or being in possession of the registration number corresponding to the particular client device 270. For example, in some exemplary embodiments, the registration number and the passive NFC device may be provided to the consumer together in a securely sealed package. In other exemplary embodiments, any other known method of securely delivering a registration number corresponding to a particular client device may be contemplated and provided as desired.

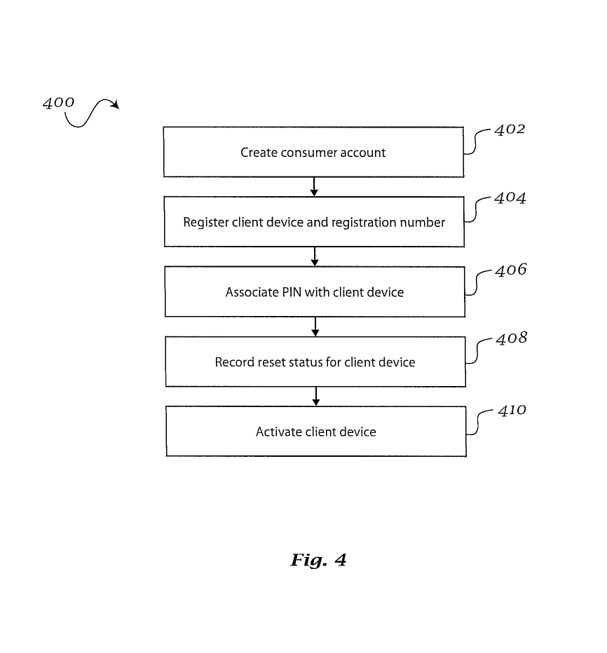

FIG. 4 shows an exemplary method 400 of registering a client device with a provider. At step 402, a consumer account with the provider may be created by any known method, for example via a web interface. In creating the consumer account, the consumer may provide personal information as well as information relating to the provision of funds to the account, for example bank account numbers, credit card account numbers, or information facilitating access to any other known funding source for the account. Funding of the account may be negotiated between the consumer and the provider, and may be facilitated by any payment method known in the art. It should be appreciated that a consumer may register a plurality of client devices, and that a plurality of consumers may be registered with the provider.

The consumer may be in possession of a client device 270 and a corresponding registration number. However, if the consumer is not in possession of a client device and corresponding registration number, the consumer may request them via the interface, in some exemplary embodiments. At step 404, the client device 270 and the corresponding registration number may be registered with the provider. At step 406, the consumer may create a PIN, or may be assigned a PIN, and the PIN may then be associated with the client device 270. Consequently, the personal and funding information provided by the consumer may be associated with the registration number, PIN, serial number 276, and tag number 280 of the client device 270, and stored in database 204.

At step 408, provider server 202 may assign a “reset” status to the client device 270. The reset status may be recorded in database 204 and associated with the particular client device 270. The reset status may indicate to provider server 202 to ignore the contents of circular buffer 282 of client device 270 during the authorization process for the next transaction. At step 410, client device 270 may be activated by the provider.

It should be appreciated that, in the event of corruption of the memory of a client device, the consumer may access their account so as to reinstate the reset status for his device. At that point, the consumer may need to select a new PIN and carry out any other desired steps to facilitate authenticity. The reset status can indicate to the provider that the transaction history of the device may be ignored during the authorization process for the next transaction, as described further below.

It should be appreciated that a plurality of merchants may register merchant accounts with a provider. Merchant account registration and any associated negotiations may be performed by any known process. For each registered merchant, the provider can assign a unique merchant ID and unique authorization credentials specific to the particular merchant.

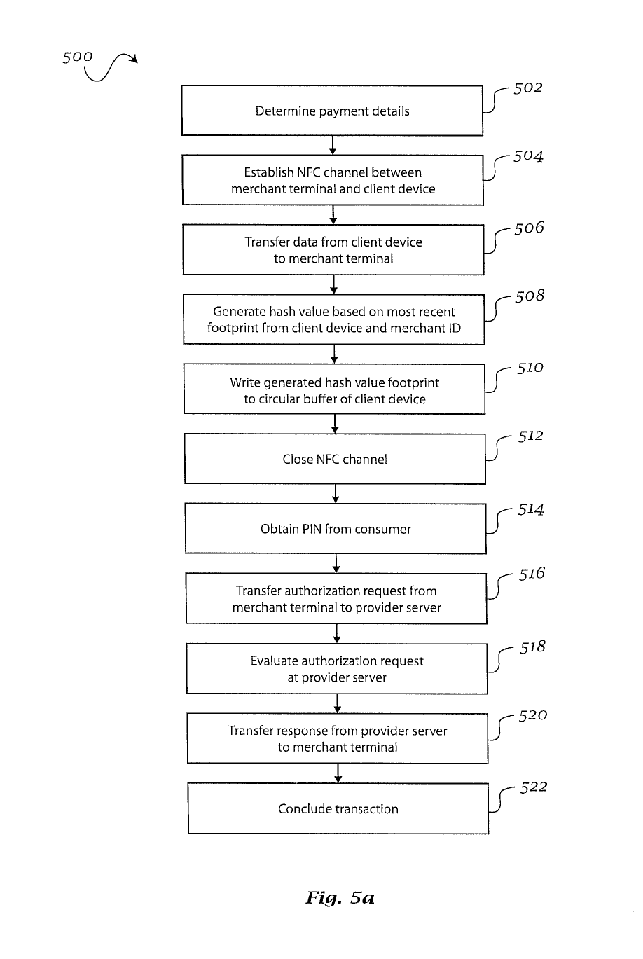

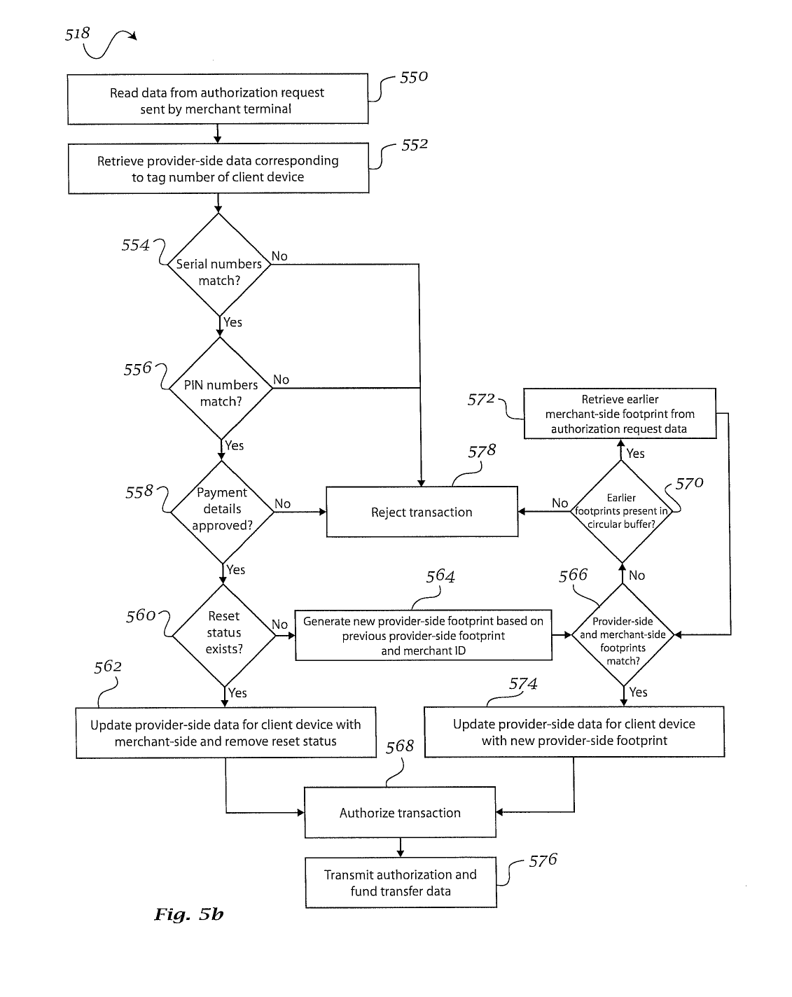

FIG. 5a illustrates an exemplary method for secure transactions 500. At step 502, the consumer and merchant may determine payment details for a transaction, including the nature of the products and/or services involved in the transaction and an agreed-upon price for the transaction. At step 504, an NFC channel 222 may be established between the client device 270 and merchant terminal 250, for example by the consumer placing client device 270 in proximity to an NFC tag reader of merchant terminal 250.

Once the NFC channel is established, data may be transferred from client device 270 to merchant terminal 250, at step 506. Such data may include the serial number 276 of client device 270, the unique tag number 280 of client device 270, and the contents of circular buffer 282 of client device 270. As described above, the circular buffer 282 may contain at least one footprint stored therein. At step 508, merchant terminal 250 may generate a hash value from the most recent footprint present in circular buffer 282 and the unique merchant ID assigned to the particular merchant. If client device 270 has been previously used in a transaction, the most recent footprint present in circular buffer 282 may be a footprint generated from a previous transaction, as will be further described below. If client device 270 has not been used in a transaction, circular buffer 282 may contain the data written thereto during initialization step 312.

At step 510, merchant terminal 250 may write the hash value generated at step 508 into the circular buffer 282 of client device 270. The hash value may be written in a sequential manner into an available memory location in the circular buffer following the most recent footprint. Once written into circular buffer 282, the generated hash value may constitute the most recent footprint present in circular buffer 282. At step 512, the NFC channel 222 between merchant terminal 250 and client device 270 may be closed. Steps 504 through 512 may be performed in quick succession, with a low turnaround time between step 506 and step 510. This can allow the client device 270 to be maintained in the scanning area for a short time. The remainder of method 500 may not require further communication between client device 270 and merchant terminal 250.

Subsequently, at step 514, the consumer may provide their PIN to the merchant, for example by entering the PIN into merchant terminal 250 by any known manner. At step 516, merchant terminal 250 may submit an authorization request to provider server 202. The authorization request may include the payment details of the transaction, the merchant ID, the PIN, the serial number 276 of client device 270, the unique tag number 280 of client device 270, and the contents of circular buffer 282 of client device 270, including the most recent footprint generated by merchant terminal 250 at step 508. At step 518, provider server 202 may evaluate the authorization request sent from merchant terminal 250. Step 518 may be implemented by comparing the data sent in the authorization request to the data stored in database 204 corresponding to the particular client device 270, as described further below. At step 520, a response to the authorization request may be transferred from provider server 202 to merchant terminal 250. Finally, at step 522, the consumer and the merchant may conclude the transaction. If the authorization request was approved, the transaction may be concluded via exchange of agreed-upon funds and goods or services. If the authorization request was denied, the transaction may be cancelled.

FIG. 5b shows an exemplary authorization method 518. At step 550, provider server 202 may read the data sent by merchant terminal 250 in the authorization request at step 516, including tag number 280 of client device 270. At step 552, provider server 202 may retrieve a data record from database 204 corresponding to the tag number 280 sent in the authorization request. At step 554, the serial number 276 sent in the authorization request may be compared to the serial number 276 stored in the record for the client device 270 in database 204. If the received serial number does not match the stored serial number, the transaction may be rejected, at step 578. At step 556, the PIN received via the authorization request may be compared to the PIN stored in the record for the client device 270 in database 204. If the received PIN does not match the stored PIN, the transaction may be rejected, at step 578.

At step 558, the provider server 204 may analyze the payment details received via the authorization request. If the payment details do not match desired criteria for payment, the transaction may be rejected, at step 578. The payment criteria may be any criteria set by the provider for executing a financial transaction, such as payment amount, availability of funds, frequency and number of transactions, transaction location, or any other desired criteria set by the provider.

At step 560, the provider server 202 may determine whether the database record for client device 270 has a “reset” status. The presence of a reset status can indicate to provider server 202 that any footprints stored in the database record for client device 270, or the absence of footprints in the database record for client device 270, may be ignored. Therefore, if a reset status exists for client device 270, provider server 202 may, at step 562, update the database record for client device 270 with the most recent footprint that was generated at step 508 by the merchant, and remove the reset status. Subsequently, provider server may approve the transaction at step 568.

If no reset status exists, at step 564, the provider server 202 may create a provider-side footprint by generating a hash value from the merchant ID sent by the merchant, and the previous provider-side footprint stored in the database record for client device 270. At step 566, the provider server 202 may compare the provider-side footprint generated at step 564 to the most recent footprint which was generated at step 508 by the merchant terminal 250. If the provider-side and merchant-side footprints match, provider server may, at step 574, record the provider-side footprint in the database record for the client device 270. Subsequently, provider server 202 may authorize the transaction at step 568. If the provider-side and merchant-side footprints do not match, provider server 202 may enter a “provisional acceptance” mode.

In the provisional acceptance mode, at step 570, provider server 202 may determine if there are any earlier footprints present in the contents of circular buffer 282. If earlier footprints exist, at step 572, provider server may retrieve an earlier footprint from the contents of circular buffer 282, which were included in the authorization request sent by merchant server 250. Subsequently, provider server 202 may execute the comparison step 566. If the footprints match, provider server 202 may, at step 574, record the provider-side footprint in the database record for the client device 270. Subsequently, provider server 202 may authorize the transaction at step 568. If the footprints do not match, provider server 202 may repeat steps 570-572. If no earlier footprints are found at step 572, that is, if all footprints present in the contents of circular buffer 282 have already been compared, the provider server 202 may reject the transaction, at step 578.

Subsequent to authorization, at step 576, provider server 202 may send notification of authorization, along with any other desired information for fund transfer and execution of the transaction, to merchant device 250.

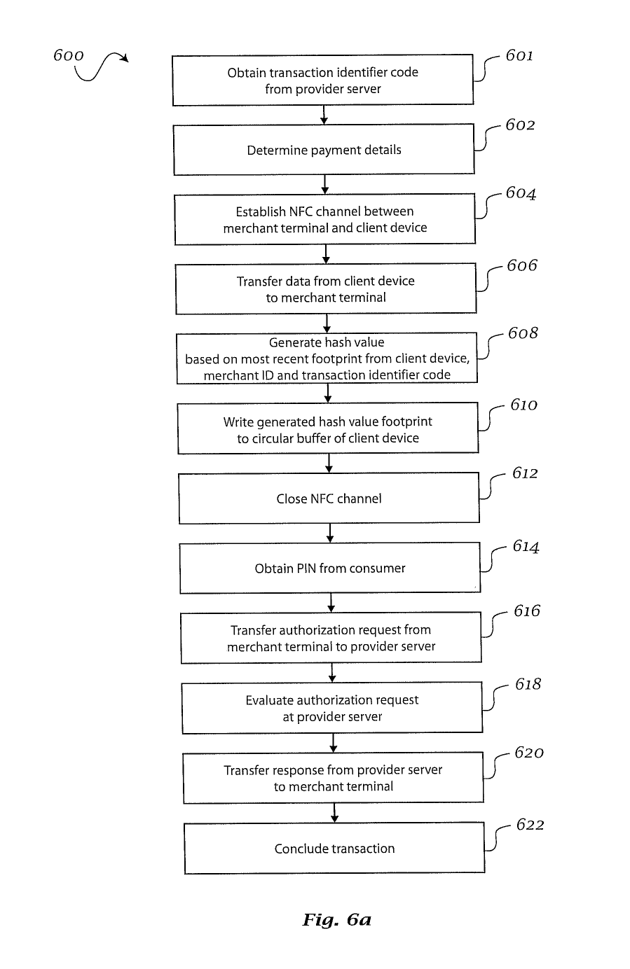

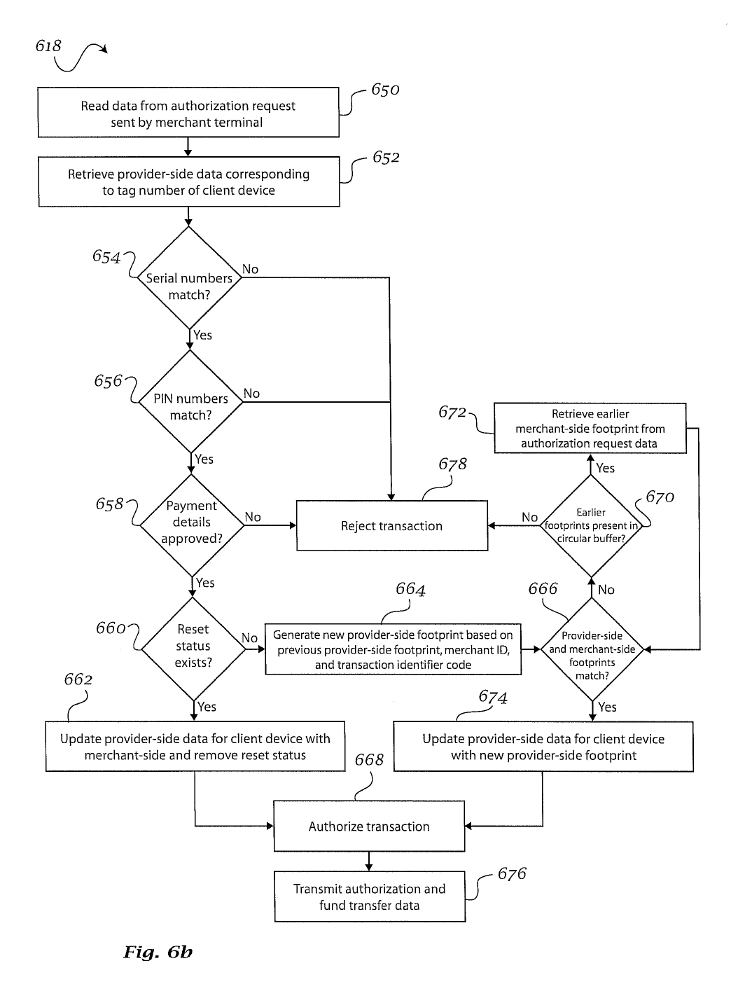

FIG. 6a illustrates an exemplary extended security method for secure transactions 600. The extended security method 600 can be distinguished from method 500 by the provision of an additional transaction identifier code. The transaction identifier code may be any desired sequence of data, and may be randomly or pseudorandomly generated. The transaction identifier code can serve to “salt” the hash functions for generating the footprints described in method 600.

At step 602, the merchant terminal 250 may obtain a transaction identifier code from provider server 202. This step may be performed at any point between the termination of the previous transaction and the commencement of the current transaction. At step 602, the consumer and merchant may determine payment details for a transaction, including the nature of the products and/or services involved in the transaction and an agreed-upon price for the transaction. At step 604, an NFC channel 222 may be established between the client device 270 and merchant terminal 250, for example by the consumer placing client device 270 in proximity to an NFC tag reader of merchant terminal 250.

Once the NFC channel is established, data may be transferred from client device 270 to merchant terminal 250, at step 606. Such data may include the serial number 276 of client device 270, the unique tag number 280 of client device 270, and the contents of circular buffer 282 of client device 270. As described above, the circular buffer 282 may contain at least one footprint stored therein. At step 608, merchant terminal 250 may generate a hash value from the most recent footprint present in circular buffer 282, the unique merchant ID assigned to the particular merchant, and the transaction identifier code obtained at step 601. If client device 270 has been previously used in a transaction, the most recent footprint present in circular buffer 282 may be a footprint generated from a previous transaction, as will be further described below. If client device 270 has not been used in a transaction, circular buffer 282 may contain the data written thereto during initialization step 312.

At step 610, merchant terminal 250 may write the hash value generated at step 608 into the circular buffer 282 of client device 270. The hash value may be written in a sequential manner into an available memory location in the circular buffer following the most recent footprint. Once written into circular buffer 282, the generated hash value may constitute the most recent footprint present in circular buffer 282. At step 612, the NFC channel 222 between merchant terminal 250 and client device 270 may be closed. Steps 604 through 612 may be performed in quick succession, with a low turnaround time between step 606 and step 610. This can allow the client device 270 to be maintained in the scanning area for a short time. The remainder of method 600 may not require further communication between client device 270 and merchant terminal 250.

Subsequently, at step 614, the consumer may provide their PIN to the merchant, for example by entering the PIN into merchant terminal 250 by any known manner. At step 616, merchant terminal 250 may submit an authorization request to provider server 202. The authorization request may include the payment details of the transaction, the merchant ID, the transaction identifier code obtained at step 601, the PIN, the serial number 276 of client device 270, the unique tag number 280 of client device 270, and the contents of circular buffer 282 of client device 270, including the most recent footprint generated by merchant terminal 250 at step 608. At step 618, provider server 202 may evaluate the authorization request sent from merchant terminal 250. Step 618 may be implemented by comparing the data sent in the authorization request to the data stored in database 204 corresponding to the particular client device 270, as described further below. At step 620, a response to the authorization request may be transferred from provider server 202 to merchant terminal 250. Finally, at step 622, the consumer and the merchant may conclude the transaction. If the authorization request was approved, the transaction may be concluded via exchange of agreed-upon funds and goods or services. If the authorization request was denied, the transaction may be cancelled.

FIG. 6b shows an exemplary authorization method 618. At step 650, provider server 202 may read the data sent by merchant terminal 250 in the authorization request at step 616, including tag number 280 of client device 270. At step 652, provider server 202 may retrieve a data record from database 204 corresponding to the tag number 280 sent in the authorization request. At step 654, the serial number 276 sent in the authorization request may be compared to the serial number 276 stored in the record for the client device 270 in database 204. If the received serial number does not match the stored serial number, the transaction may be rejected, at step 678. At step 656, the PIN received via the authorization request may be compared to the PIN stored in the record for the client device 270 in database 204. If the received PIN does not match the stored PIN, the transaction may be rejected, at step 678.

At step 658, the provider server 204 may analyze the payment details received via the authorization request. If the payment details do not match desired criteria for payment, the transaction may be rejected, at step 678. The payment criteria may be any criteria set by the provider for executing a financial transaction, such as payment amount, availability of funds, frequency and number of transactions, transaction location, or any other desired criteria set by the provider.

At step 660, the provider server 202 may determine whether the database record for client device 270 has a “reset” status. The presence of a reset status can indicate to provider server 202 that any footprints stored in the database record for client device 270, or the absence of footprints in the database record for client device 270, may be ignored. Therefore, if a reset status exists for client device 270, provider server 202 may, at step 662, update the database record for client device 270 with the most recent footprint that was generated at step 608 by the merchant, and remove the reset status. Subsequently, provider server may approve the transaction at step 668.

If no reset status exists, at step 664, the provider server 202 may create a provider-side footprint by generating a hash value from the merchant ID sent by the merchant, the transaction identifier code sent by the merchant, and the previous provider-side footprint stored in the database record for client device 270. At step 666, the provider server 202 may compare the provider-side footprint generated at step 664 to the most recent footprint which was generated at step 608 by the merchant terminal 250. If the provider-side and merchant-side footprints match, provider server may, at step 674, record the provider-side footprint in the database record for the client device 270. Subsequently, provider server 202 may authorize the transaction at step 668. If the provider-side and merchant-side footprints do not match, provider server 202 may enter a “provisional acceptance” mode.

In the provisional acceptance mode, at step 670, provider server 202 may determine if there are any earlier footprints present in the contents of circular buffer 282. If earlier footprints exist, at step 672, provider server may retrieve an earlier footprint from the contents of circular buffer 282, which were included in the authorization request sent by merchant server 250. Subsequently, provider server 202 may execute the comparison step 666. If the footprints match, provider server 202 may, at step 674, record the provider-side footprint in the database record for the client device 270. Subsequently, provider server 202 may authorize the transaction at step 668. If the footprints do not match, provider server 202 may repeat steps 670-672. If no earlier footprints are found at step 672, that is, if all footprints present in the contents of circular buffer 282 have already been compared, the provider server 202 may reject the transaction, at step 678.

Subsequent to authorization, at step 676, provider server 202 may send notification of authorization, along with any other desired information for fluid transfer and execution of the transaction, to merchant device 250.

Advantages of the embodiments described herein may include that client devices that are not supplied by the provider may not be used to execute payment, and may not be allowed to interfere with the payment process and system. Furthermore, for a client device to be recognized as valid, each client device may need to include the correct serial number and unique tag number, both of which would need to match the numbers stored by the provider as corresponding to the particular client device. Additionally, any authorization request message used with the embodiments disclosed herein can include the PIN, which would need to match the PIN stored by the provider as corresponding to the particular client device.

Additionally, advantages of the embodiments disclosed herein may include impeding forgeries. The likelihood of a forgery authorizing payments may be reduced, and the likelihood of a forgery disrupting payments made by the original client device held by the consumer may also be reduced. The embodiments disclosed herein can facilitate ease of detection of forgeries by the provider, subsequent to which the consumer may be alerted of the forgery attempt.

The provider-side identification of a client device by its unique tag number can facilitate several layers of protection against forgeries. A serial number of a client device, in some scenarios, may be predictable by a forger due to the sequential nature of the serial numbers. However, the tag number, which is generated by the provider, may be unlikely to be predictable by a forger. Additionally, as serial numbers may not be unique when taking into account multiple manufacturers of client devices, identification of the client device by the tag number may allow the provider to confirm that the client device is intended to be used with the secure transaction system. Furthermore, any authorization request message used with the embodiments disclosed herein can necessitate that both a serial number and the tag number of the client device match. Once the client device is identified by the tag number, the client device serial number and the provider-side stored serial number corresponding to the tag number may be compared to each other to determine a match between the serial numbers. As it is known that copying a serial number of a client device presents increased difficulty, matching the serial numbers can serve as another additional protection against forgeries. Thus, even if the client device were forged such that the data stored in the memory thereof was duplicated, the serial number of the forged client device may nevertheless be different from the genuine client device. Therefore, even if a forger is aware of the PIN, the transaction may still be rejected due to the mismatch between the serial number of the forged device and the server-side stored serial number corresponding to the tag number of the device.

Additionally, any authorization for a transaction may necessitate that the merchant conducting the transaction have an account with a provider, thereby limiting the amount of locations where the client device or forgery may be used. Excessive rejected transactions can be furthermore be detected by the provider and the consumer may be alerted. Additionally, as new footprints are constructed based on the previous footprints stored on the client device and on the provider server, a forged device may only copy the original device at a fixed point in time. Therefore, any new transaction on the original device can identify the forgery as such, as the forgery will not be able to produce the correct footprints. Furthermore, the footprint generated by the merchant server can require a client device to have a recent transaction history matching the transaction history as stored by the provider. A successful transaction by a forgery can alter the provider-side transaction history, thereby allowing the provider to detect a mismatched footprint upon any further transactions by the original. Upon detection of a mismatched footprint by the provider, the consumer can be alerted to the possible existence of a forgery. When a possible existence of a forgery is detected, the provider may choose to suspend the account of the consumer until the consumer takes any steps necessary to facilitate authenticity and security of the account. The embodiments described herein thus provide increased security for NFC transactions.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method for authorizing a transaction between a first party utilizing a client device and a second party, comprising:
receiving an authorization request from the second party, the authorization request including first party data and second party data;
retrieving stored data corresponding to the first party;
comparing at least a portion of the first party data to at least a portion of the stored data corresponding to the first party;
generating a first hash value from at least a portion of the authorization request;
generating a second hash value from at least a portion of the stored data and at least a portion of the authorization request; and
comparing the first hash value and the second hash value.

2. The method of claim 1, wherein:
the first party data includes a first client device identification data and a first transaction history of the client device, the first transaction history including at least one footprint;
the second party data includes a second party identification; and
the stored data includes a second client device identification data and a second transaction history of the client device, the second transaction history including at least one footprint.

3. The method of claim 2, wherein comparing at least a portion of the first party data to at least a portion of the stored data includes comparing the first client device identification data to the second client device identification data.

4. The method of claim 2, wherein:
the first client device identification data includes a serial number of the client device, a tag number of the client device, and a personal identification number associated with the client device; and
the second client device identification data includes a serial number of the client device, a tag number of the client device, and a personal identification number associated with the client device.

5. The method of claim 2 wherein:
generating a first hash value includes generating a hash value from the at least one footprint of the first transaction history and the second party identification; and
generating a second hash value includes generating a hash value from the at least one footprint of the second transaction history and the second party identification.

6. The method of claim 1, wherein the authorization request further includes a transaction identifier code.

7. The method of claim 6 wherein:
generating a first hash value includes generating a hash value from the at least one footprint of the first transaction history, and the second party identification, the transaction identifier code; and
generating a second hash value includes generating a hash value from the at least one footprint of the second transaction history, the second party identification, and the transaction identifier code.

8. A method for secure NFC transactions, comprising:
establishing an NFC channel between a client device and a terminal of a first party having a first party identification number;
transferring client device data from the client device to the terminal;
generating a first hash value from at least a portion of the client device data and the first party identification number;
writing the first hash value to a memory of the client device;
closing the NFC channel;
obtaining a personal identification number from a user of the client device;
transmitting an authorization request from the terminal to a second party; and
obtaining a response, from the second party, to the authorization request.

9. The method of claim 8, wherein the client device data includes a client device serial number, a client device tag number, and a client device transaction history, the transaction history including at least one footprint.

10. The method of claim 9, further comprising evaluating the authorization request by the second party.

11. The method of claim 10, wherein the authorization request comprises:
the first party identification number;
the personal identification number;
the client device serial number;
the client device tag number;
a new footprint, the new footprint including the first hash value; and
the client device transaction history.

12. The method of claim 11, wherein generating a first hash value includes generating a hash value from the at least one footprint of the client device transaction history and the first party identification number.

13. The method of claim 12, wherein evaluating the authorization request comprises:
matching the client device tag number to a stored tag number stored by the second party;
comparing the client device serial number of the authorization request to a stored serial number stored by the second party and associated with the stored tag number;
comparing the personal identification number to a stored personal identification number stored by the second party and associated with the stored tag number;
retrieving a stored footprint stored by the second party and associated with the stored tag number;
generating a second hash value from the stored footprint and the first party identification number; and
comparing the second hash value to the new footprint of the authorization request.

14. The method of claim 10, further comprising obtaining a transaction identification number from the second party.

15. The method of claim 14, wherein the authorization request comprises:
the first party identification number;
the personal identification number;
the transaction identification number;
the client device serial number;
the client device tag number;
a new footprint, the new footprint including the first hash value; and
the client device transaction history.

16. The method of claim 15, wherein generating a first hash value includes generating a first hash value from the at least one footprint of the client device transaction history, the transaction identification number, and the first party identification number.

17. The method of claim 16, wherein evaluating the authorization request comprises:
matching the client device tag number to a stored tag number stored by the second party;
comparing the client device serial number of the authorization request to a stored serial number stored by the second party and associated with the stored tag number;
comparing the personal identification number to a stored personal identification number stored by the second party and associated with the stored tag number;
retrieving a stored footprint stored by the second party and associated with the stored tag number;
generating a second hash value from the stored footprint, the transaction identification number, and the first party identification number; and
comparing the second hash value to the new footprint of the authorization request.

18. A system for secure NFC transactions, comprising:
at least one client device, the client device having a client device data and a client device transaction history stored thereon;
at least one merchant terminal having a merchant identification number and operable to establish a communication channel with the at least one client device, retrieve the client device data and the client device transaction history, generate a first hash value based at least on the merchant identification number and the client device transaction history, write the first hash value to the transaction history of the client device, and generate and send an authorization request, the authorization request containing the client device data, the client device transaction history, and the merchant identification number; and
a provider server in communication with the merchant terminal and operable to receive the authorization request, compare the client device data to a server-side data associated with the client device, generate a second hash value based on the merchant identification number and a server-side transaction history associated with the client device, and compare the first hash value to the second hash value.

19. The system of claim 18, wherein:
the client device identification data includes a serial number of the client device, a tag number of the client device, and a personal identification number associated with the client device; and
the server-side data associated with the client device includes a serial number of the client device, a tag number of the client device, and a personal identification number associated with the client device.

20. The system of claim 18, wherein:
the first hash value is generated from the merchant party identification number and at least one footprint of the client device transaction history; and
the second hash value is generated from the merchant party identification number and at least one footprint of the server-side transaction history.
